(19) United States
(12) Patent Application Publication
(10) Pub. No.: US 2022/0128363 A1
(43) Pub. Date: Apr. 28, 2022

(54) System and method for Continuous Path Regulator (CPR)

(71) Applicant: David Wayne Russell, Winter Garden, FL (US)

(72) Inventor: David Wayne Russell, Winter Garden, FL (US)

(21) Appl. No.: 17/079,424

(22) Filed: Oct. 24, 2020

(51) Int. Cl. G01C 21/20; B25J 9/16; G05D 1/02; G06F 17/12

(52) U.S. Cl. CPC G01C 21/20; G06F 17/12; G05D 1/0212; B25J 9/1664

(57) ABSTRACT

A solution to a system of simultaneous equations where an exact mathematical solution to a multivariate signal path or physical trajectory problem includes time and allows a control regulator to maintain high accuracy simultaneously over multiple variables such as but not limited to distance, velocity, and time. In a flight vehicle, for example, the regulator maintains with high accuracy the position of the vehicle in X, Y, and Z at exactly the time required over the entire trajectory making its position highly predictable at any time.

### CROSS-REFERENCE TO RELATED APPLICATIONS

This application claims the benefit of U.S. Provisional Patent Application Ser. No. 62/926,518, filed on Oct. 27, 2019, the contents of which are herein incorporated by reference in their entirety.

### FIELD OF THE INVENTION

The field of the invention relates generally control system design. In particular for the control of systems where time and position or control signal value are simultaneous required parameters of the control system.

### BACKGROUND OF THE INVENTION

Control system regulators such as the Proportional, Integral, Derivative (PID) controller have been used for decades to provide a simple and reliable methodology for creating a controlled transition from one state of a control signal to another. The time that is required for the transition to take place is variable depending on the differences between to prior state and the next state and loading of the system.

It must be noted, however, that the PID controller is often utilized as a first order approximation of higher order control systems. As such, the tuning required and errors created within the control system because the solution is only an approximation yields less than optimal results such as but not limited to overdamping, underdamping, and/or oscillation.

In other systems, controllers are tasked with transitioning control signals that are inherently part of a trajectory, choreography, or other control system types that require time as one of the required parameters of the control signal. Examples of this abound in robotics, animatronics, and in-flight path management where simultaneous control of when and where a vehicle, joint, or arm is at any point is time is crucial and the timing is invariant.

In these environments a new methodology such as CPR for simultaneously controlling spatial and temporal requirements with high accuracy is needed.

### SUMMARY OF THE INVENTION

It should be appreciated that this Summary is provided to introduce a selection of concepts in a simplified form that are further described below in the Detailed Description. This summary is not intended to be used to limit the scope of the claimed subject manner.

There are two aspects of higher dimensional and higher order system that need to be recognized. First that a control system may be equally dependent on time as one dimension as it is dependent on one more physical dimensions such as those referred to by Cartesian coordinates often denoted as X, Y, and Z. Secondly, the transfer function from one state to another may not be a first order equation such as Y=mX+b but higher orders such as aX\hat{ }2+bX+c.

In order to create a “Correct by Construction” solution to these problems, we must first be able to define the overall control structure mathematically, and then find an exact solution. To define the control structure, we will first define a trajectory.

The trajectory of a control system defines the physical and temporal mathematical equations which govern the control system at any instant of time, and indeed at every instant of time within the limits of the trajectory. This can be derived from a number of physical points, with the understanding that the greater number of points given the closer the system becomes to being described by these mathematical equations. For example, two endpoints describe a line such as Y=mX+b. Three points can describe a curve such as aX\hat{ }2+bX+c. More points can be used to create one spline which may be of arbitrary higher order or a series of lower order splines that can describe any path through space with mathematical precision. A single spline or sequence of splines mathematically fills in the gaps between the smaller subset of given points in the Cartesian domain. In a Cartesian trajectory these sample points are often referred to as waypoints.

In this embodiment, each trajectory is conceptualized as a segment with a given average velocity. This velocity value could be a constant, graph, spline, or series of splines or line segments or other mathematical construct. The geometric order of the segment is dependent on the desired results, and one familiar with the art would see that a first order line segment, i.e. Y=mX+b or a second order segment such as Y=aX\hat{ }2+bX+c or higher order representations make no difference to the operation of the system as described. In another embodiment the assigned velocity could also be an equation of any given order or a spline or series of splines. The only requirement is that both the trajectory and the time element are expressed mathematically such that at any given time an exact value of the trajectory may be determined. In other embodiments the time given could be a factor related to time or can be mathematically computed from time such as but not limited to velocity or acceleration.

In order to simplify the architecture and computational complexity, this embodiment utilizes the fact that any system of multiple variables may be expressed in relation to an additional arbitrary variable. As velocity is one of the factors we wish to preserve with each segment and velocity is a derivative relative to Time, we can express each segment as a multivariate:

X=f(T);

Y=f(T);

Z=f(T);

In so doing we have integrated all four dimensions we seek within a single computational structure.

The final trajectory from source to destination will be an ordered list of each of these segments. In this embodiment the path will be defined as a series of splines, which provides an additional benefit in that the splines can be defined such that the velocity at the “knots” or transition points is constant. This is of great benefit to defining the paths of moving vehicles. In other embodiments different types of averaging splines, polynomials, lists, matrices, vectors, or other mathematical forms might be used to express the trajectory.

Trajectories are also of use in describing the path and timing (distance, velocity, acceleration) of moving components in robotics or in trying to mimic human-like movement in an animatronic figure. This is one case where the exact movement of the figure with respect to time is critical. Trajectories can also be created for other than Cartesian domains such as complex control signals managing multivariate electronic components over time.

Once the trajectory is created, the question becomes how to create a mathematical solution that exactly meet the requirements of that trajectory.

In this embodiment, which is depicted in FIG. 1, the control system is designed to sample one dimension of the trajectory (here we will use Z although any other dimension is roughly equivalent) with respect to time (T), as shown above that relationship is defined as Z=f(T). The sample period will be defined as T1−T0. From the trajectory, each point in Z can be solved from the Z=f(T) equation such that Z0 is the initial position of the system at T=T0 and Z1 is the position of the system at T1.

Because the trajectory contains the position for all points of Z over time, it is also true that Z2 will be the position of the system at T2 where for this embodiment T2−T1=T1−T0 although this is not a requirement. The calculation can also be simplified such that T0 can be denoted for any point N in the limits of the trajectory and point N1 is denoted at T1. At the next consecutive sample, T1 becomes T0, T2 becomes T1, and the calculations continue.

We can then postulate a system where the initial state exists at T0, Z0, and an initial velocity V0. At the beginning of the trajectory V0 may be equal to 0, but as it will be shown V0 can be any velocity as the control system operates. It is often the case that V1 may also be 0 at the end of the trajectory, although there is no requirement as such.

The end state of the system at T1 consists of time T1, location Z1, and from Z2−Z1 we can formulate the output velocity of this state as V1.

This provides us with the mathematical requirement that the control system will provide the transition signal, in this embodiment the velocity of the Z dimension, such that the Z dimension travels from Z0 to Z1 and the velocity transitions from V0 to V1 during the exact time T0 to T1. In another embodiment, any one of the dimensions such as but not limited to distance (here Z), velocity (V) and Time (T) can be used as the variable with which to control one of the other three. This provides considerable freedom to vary the system to the control system circumstanced required, such as but not limited to varying the sample frequency instead of the velocity to control distance.

For this to occur, we will utilize a curve of the velocity of Z, aZ\hat{ }2+bZ+c=0. The distance traveled from Z0 to Z1 is equal to the area under this curve between T0 and T1. That area can be found by integrating the function and evaluating at the given time. We know from Z1−Z0 the distance to be traveled which is equal to the area under the curve.

We then have two equations and two unknowns:

aZ\hat{ }2+bZ+V0=0(c=V0 at Z=0)

The Integral of (aZ\hat{ }2+bZ+V0=0)=(Z1−Z0). When the integral is evaluated between T0 and T1 the result equals Z1−Z0.

This can be solved for (a) and (b), which gives us the exact solution for the transfer function of the velocity at V0 to the velocity at V1 with the exact distance covered Z1−Z0 in the time sample T1−T0.

Once the control system reaches T1, the calculation is set such that T1 becomes the new T0, Z1 becomes Z0, V1 becomes V0 and the next sample window determines the new parameters for T1, Z1, and V1 from the trajectory functions.

This equation is tolerant of any transitory phenomena (within one sample time) that might occur due to external environmental forces, internal numerical errors, or mechanical issues such as propeller or motor imbalance.

This cycle can be maintained from one sample time to the next throughout the trajectory yielding an exact numerical control for simultaneously maintaining the correct position and time.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of illustrative embodiments of the present disclosure when read in conjunction with the accompanying drawings, wherein:

FIG. 1 depicts an example of the Velocity/Time equation functions.

FIG. 2 depicts the block diagram of an exemplar control system.

FIG. 3 depicts a 3D plot of the trajectory in X, Y, Z related to Latitude, Longitude, and Altitude.

FIG. 4 depicts a plot of the Z samples taken from the trajectory.

FIG. 5 depicts a plot of the splines providing a mathematical fit of the Z trajectory.

FIG. 6 depicts the transfer function of the first second of the exemplar trajectory.

FIG. 7 depicts the transfer function of the second sample of the exemplar trajectory.

FIG. 8 depicts the transfer function of the third sample of the exemplar trajectory.

FIG. 9 depicts the trajectory sample locations and actual path of the first five seconds of the exemplar trajectory.

FIG. 10 depicts the control velocity curve of the first five seconds of the exemplar trajectory.

FIG. 11 depicts the total plot of sample locations and actual path for the full trajectory.

FIG. 12 depicts the velocity curve of the full trajectory.

FIG. 13 depicts the addition of random wind as external forces acting on the simulated trajectory.

FIG. 14 depicts the total plot of planned locations and actual path with wind.

FIG. 15 depicts a zoomed-in plot of one section of the planned trajectory and actual path with wind.

FIG. 16 depicts the control velocity curve with wind for the full trajectory.

FIG. 17 depicts full trajectory with wind and the second error function added.

FIG. 18 depicts a zoomed-in plot of one section of the planned trajectory and actual path, wind, and second error term added.

FIG. 19 depicts a plot of the second error term reacting to the injected wind velocity.

FIG. 20 depicts the control velocity output with wind and second error term.

FIG. 21 depicts the calculated polynomial used as the template for the entire solution.

### DETAILED DESCRIPTION OF THE INVENTION

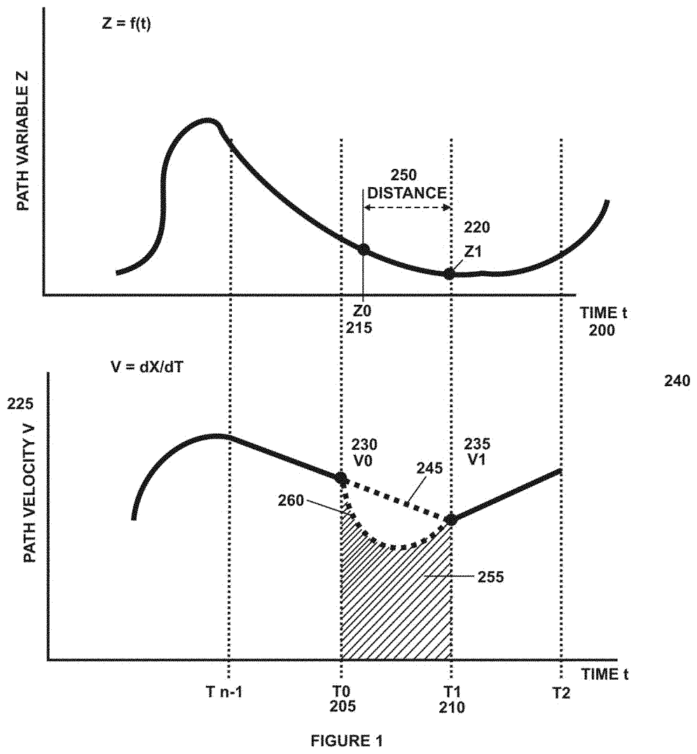

Referring now to the invention in more detail, in FIG. 1 there is shown a graph depicting the relationships between the distance, velocity, and time parameters of the control system. The different illustrative embodiments recognize and take into account a number of different considerations. “A number”, as used herein with reference to items, means one or more items. For example, “a number of different considerations” means one or more different considerations. Unless otherwise noted X and Y are intended to reference ground width and breadth as in a Cartesian coordinate system, and Z is intended to reference altitude, height, or altitude Above Ground Level (AGL). The spatial orientation could be other orientations such as NED (North, East, Down as designations of X, Y, and Z respectively without changing the intent of the invention.

The number of physical and temporal dimensions are shown as 3 or more for illustrative purposes, however more or fewer physical and multiple temporal dimensions are possible without altering the intent of the invention. While the words “flight path” may be used for illustrative purposes, the physical and temporal dimensions of the resultant trajectory may be utilized in any environment with moving parts from flight vehicles to surface vehicles to self-adjusting shelving. One or more dimensions of control signals which do not relate to physical or Cartesian coordinates are also possible.

FIG. 1 depicts the foundation for the CPR. In this embodiment the horizontal axis 200 is Time, from T0 205 to T1 210. We will also depict the horizontal axis as Distance 250, from Z0 215 to Z1 220. The vertical axis 225 is Velocity. The left edge T0 intercept is V0 230 and the right edge T1 intercept is V1 235. In this exemplar typical of one time step of the regulator, the final actual velocity prior to this step was V0 (regardless of whether this was the average or anticipated velocity for that segment) and the average velocity calculated for the next segment is V1. The actual endpoint of distance from the last time step is Z0, again regardless of the expected end location of the step. The expected start of the next step is Z1.

In another embodiment the V1 values may be stored or otherwise calculated from data, data structures, or metadata embedded with the trajectory or available to the system in other ways. In another embodiment the temporal distance denoted by T1 and T0 may vary without changing the intent of the invention. Indeed the equations given above work independent of the magnitude of any of the variables with the exception the T1>T0 and Z1>Z0. As the velocity V is dependent of distance divided by time, V may be any magnitude or sign.

The purpose of the regulator then is to manage the transition from Z0 to Z1, in the exact time period of T1−T0, and to match the start and end velocities of V0 and V1 respectively. In this example, we pose the problem that the previous time step ended at a higher velocity than anticipated. The reason is immaterial. As such V0>V1 and Z0 is offset into this region such that the distance to be traveled in this step is now shorter than originally scheduled, while the time period for traversing that distance remains the same.

The ultimate goal of every calculation is to provide the exact requirements for Z to reach Z1 with velocity V1 at T1, regardless of the input conditions. As can be seen in FIG. 1, the dotted line 245 would represent the first order transition from V0 to V1. If this path were taken the distance traveled would be equal to the area under the line 255, which is (T1−T0)*(V1+((V1−V0)/2)). This distance cannot be smaller than the average velocity anticipated for the period, as is required by the advanced position of Z0 and the higher initial velocity.

It is then evident that the velocity transfer function from V0 to V1 must be a curve 260, which must fall below V1 in order to bleed off the excess speed, and then rise again to make the required exit velocity of V1. This observation provides the first equation for the numerical solution, i.e. the path of the velocity transfer function must be a curve such as but not limited to

aZ\hat{ }2+bZ+c=0

The second equation is then that the total distance traveled in this time period is represented by the area under the curve 255 (hatched area) evaluated from T0 to T1, and this in turn is equal to Z1−Z0. That can be represented as the integral of the first equation evaluated between T0 and T1. As the lowest point of this line must fall below V1 in order to reduce the excess speed, this also shows that the area under the simple transition line 245 cannot equal the distance 250.

Calculating the simultaneous solution to these two equations yields the calculations represented by the first computation block, where X here represents the input value of any dimension and V represents the first derivative of that signal value as described above:

(a)=3*(2X0−2X1−T0V0−T0V1+T1V0+T2V1)/(T0−T1)\hat{ }3

(b)=2*(3X0−3X1−2T0V0−T0V1+2T1V0+T1V1)/T0\hat{ }2−2T0T1+T1\hat{ }2

(c)=V0

This transfer function curve provides a mathematically exact solution to traversing the requisite space between Z0 and Z1 in time T1−T0, with the initial and final velocities required.

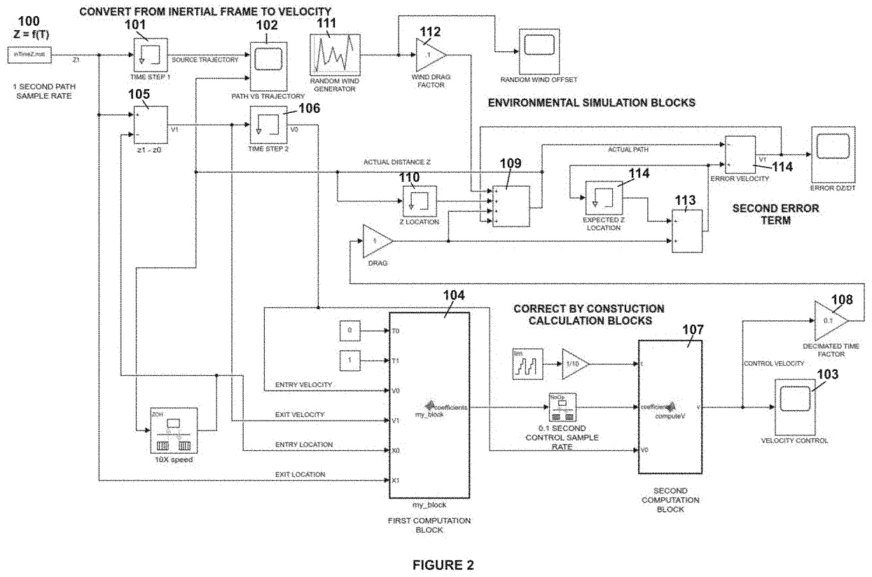

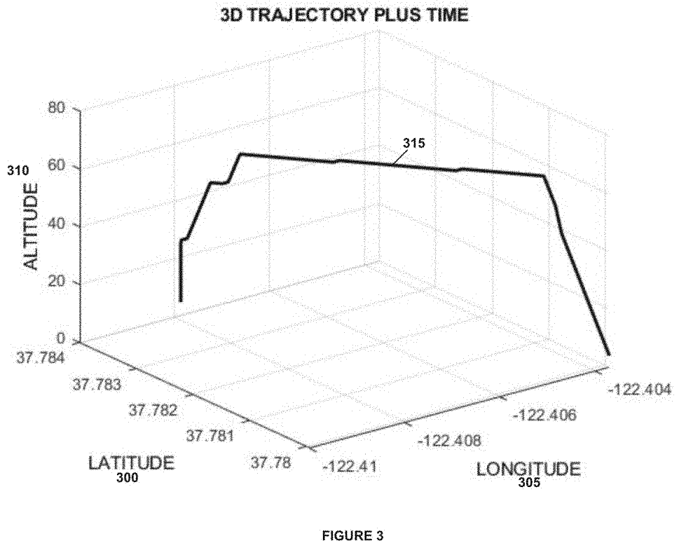

FIG. 2 depicts the flow diagram of an embodiment of a Continuous Path Regulator (CPR) control system for an exemplar trajectory. The full trajectory is shown in FIG. 3. In this diagram, the spline version of Z=f(T) is evaluated each second (trajectory sample time) 100 and is sent to the control system. Storage elements of the regulator are loaded with the initial Z0 value as well so that most initial difference calculations result in 0. Two storage time steps are then delayed 101 106 in order to get the Z1 and Z2 values into the controller as well. In some embodiments these could all be done in the same step and/or without delay. When Z2 is loaded the controller begins providing velocity data for the flight path 102 103. The first calculation block 104 receives the entry velocity V0 calculated from Z1−Z0 105 and then stored for the next time period 106. The first calculation block also receives the exit velocity V1, calculated in the same manner in the next time step. Similarly the initial Z position Z0 and final Z position Z1 are presented to the first calculation block. At the end of the time period T1, the V1 data is stored replacing V0 and a new V1 is calculated.

In this embodiment, the T0 and T1 variables are always set to 0 and 1, respectively as the time is held constant to the sample time of the trajectory while other variables interact. This is not a necessary condition, in this embodiment it simplifies the controller design to some extent. The outputs of the first calculation block are the parameters (a) and (b) relating to the equation aZ\hat{ }2+bZ+c. C is known to be equal to V0, so V0 is presented directly to the second computation block 107. The second computation block is clocked at a higher rate than the first, in this embodiment 10×, but one familiar with the art would see that different sampling ratios would not alter the fundamental aspects of the invention.

The second computation blocks evaluates the velocity curve given by (a) and (b) output by the first computation block, and provides the values represented between T0 to T1 in 0.1 second intervals. Because of the decimation subsampling, each velocity output provided is multiplied 108 by 0.1 so that the total velocity imparted is the same as (Z1−Z0)/(T1−T0). This is not a gain per se, but a computation step exactly compensating for the decimation subsampling.

To correctly simulate the resultant movement given the velocity setting of the second computation block, an arbitrary drag coefficient 108 may be applied to the velocity setting. A drag coefficient of 1 would have no effect on the velocity target setting. The velocity is then summed with previous Z locations 109 and stored. This provides the system with the amount of Z distance covered by the velocity for each time step. In addition, a random simulation of wind velocity 111 with a wind drag coefficient 112 is added in the distance computation path.

The stored value of the Z location plus the velocity for each time tick is fed back into the controller as the next Z0 and as the basis of the next V0. This completes the computation and feedback loop of the controller. Any errors in position and/or velocity are compensated for in the next time period.

In this embodiment a second error term is shown as velocity summation cycle 113, 114. This is a computation of the expected distance that the original velocity setting would have achieved without external forces such as wind. The difference 115 between this calculation of the expected distance and the actual distance results in a velocity error term which is fed back into the system. The nature of this error term will be described more fully below.

To demonstrate how this works in a complete regulator, FIG. 3 depicts a three-dimensional trajectory with Latitude 300, Longitude 305, and Altitude 310 as the Cartesian coordinates. The trajectory 315 is shown varying in all three dimensions. In addition, an average velocity of 1 m/s is applied such that nearly 500 m of distance would be covered in 500 seconds.

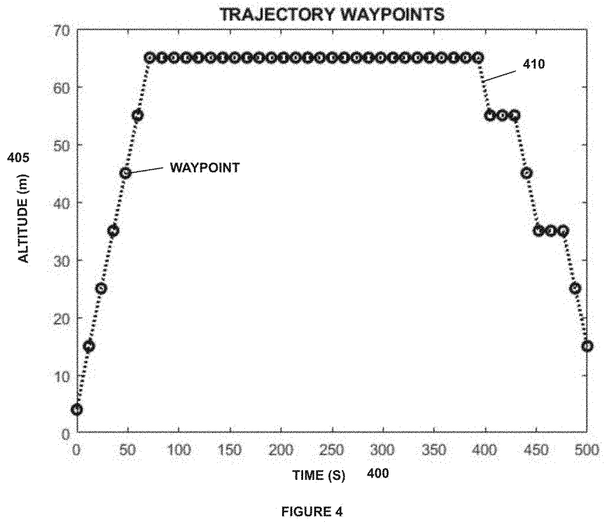

FIG. 4 depicts the Altitude dimension as Z=f(T). Time 400 is the horizontal axis, and Altitude 405 or Z is the vertical dimension. The original trajectory waypoints created by the flight planning system are shown as circles 410. Note that these waypoints are a subset of the entire path as shown by the dotted lines.

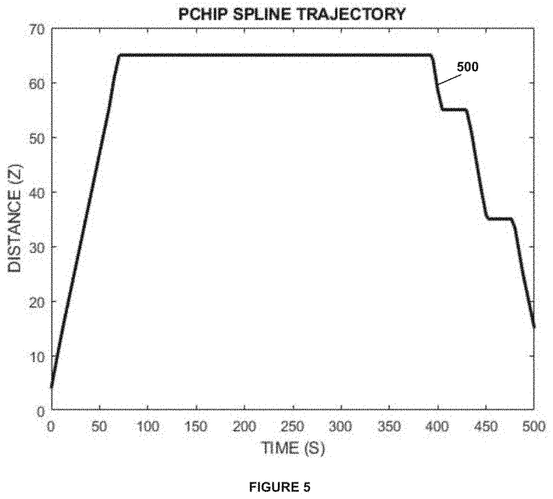

FIG. 5 depicts the same trajectory converted to a Piecewise Cubic Hermite Interpolating Polynomial, although one familiar with the art would note that the actual interpolation algorithm utilized or value storage system employed would not change the fundamental operation of the invention. The polynomial solution, however, provides any necessary solution to Z=f(T) for the regulator. In other embodiments the polynomial could be represented by higher order polynomials including but not limited to splines, or vectors or matrices of individual values that are known a priori because the time steps are known.

In this embodiment and exemplar trajectory, the system functions as follows:

In the first second of operation, the values for Z0, Z1, V0, and V1 are determined and/or loaded from the trajectory information. T0 and T1 will always equal 0 and 1 in this implementation. From the Z trajectory given in FIG. 5,

Z0=4 m (Initial altitude AGL)

Z1=4.09 m (the flight planning system starts off with slow takeoff)

V0=0 (vehicle at rest)

V1=0.0892 (the average velocity of the next section of the trajectory, (Z2−Z1)/t.

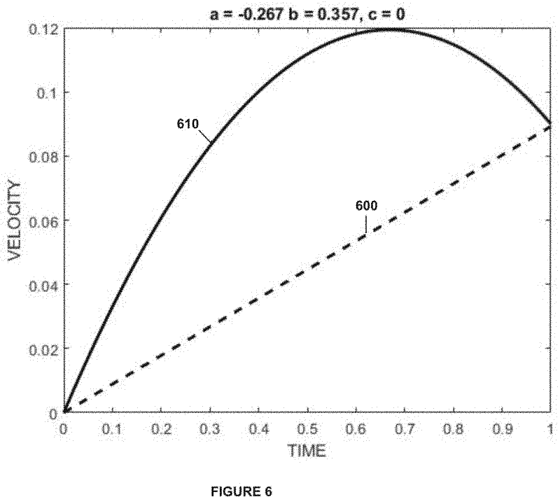

This yields the solution of (a)=−0.267 (b)=0.357 and (c)=0 as graphed in FIG. 6. Here the dotted line 600 again shows the first order approximation of the transfer function from V0 to V1 and the parabola 610 depicts the exact transfer function such that the area under the curve is 0.09 m in one second. This shows that while the average velocity may be used as an overall target, the actual velocity is determined by the transfer function as per the time and distance requirements of that sample period. In another embodiment the actual velocity of the system at V1 might be known a priori, or the velocity profile may be other than a constant. The purpose of V1 is simply to keep the exit in bounds, any error in V1 will be compensated for in the next sample solution.

In the second time period,

Z0=4.09 m

Z1=5.01 m

V0=0.0892 m/s

V1=0.919 m/s

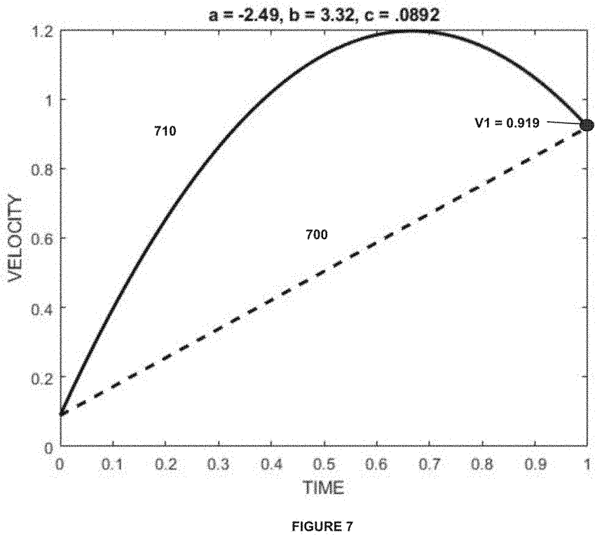

Which yields the parameters (a)=−2.49 (b)=3.32 (c)=0.0892 as shown in FIG. 7.

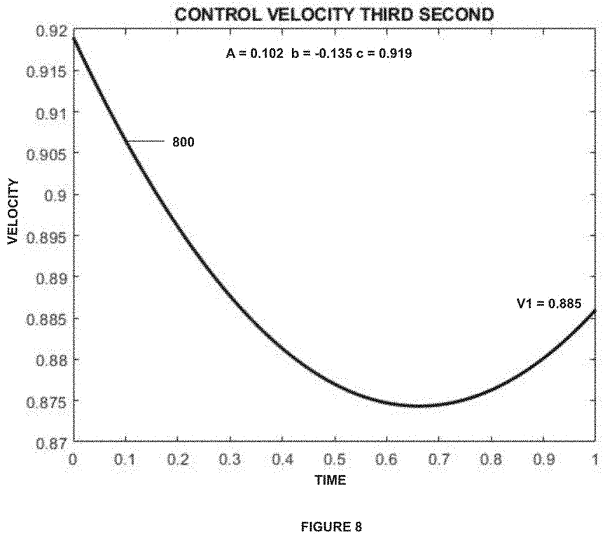

In the third time period, as shown in FIG. 8 a=0.102, b=−0.135, and c=0.919. Note that the first two parabolas opened downward, but here it opens upwards. The velocity polynomial can work either way to provide the appropriate transfer function.

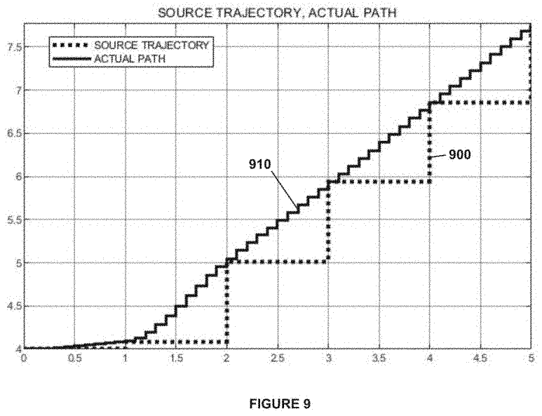

A comparison of the source trajectory 900 and the actual path simulated 910 for the first five seconds is shown in FIG. 9. This shows that the actual path follows the spline or polynomial path with high precision even though it is sampled only once per second, resulting in the stairstep plot. Because of this slow sampling rate, the error is only sampled at these points. The consequences of this slow sample rate will be detailed below. In other embodiments the sample rates may vary, or the first and second computation blocks may be at the same higher sample rate comparing against the trajectory also sampled at a higher rate. In another embodiment the sample rates may vary depending other information such as but not limited to the velocity rate of change, error rates, or ranges of values.

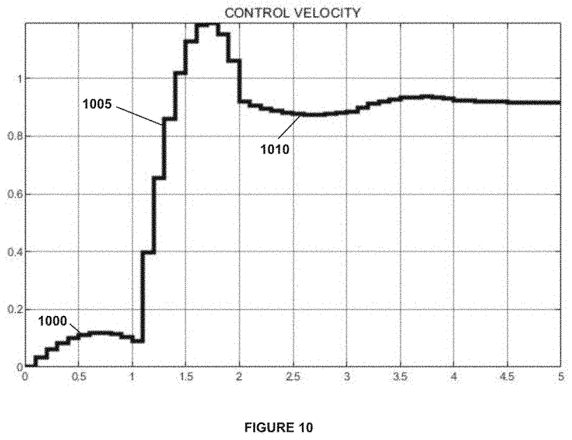

FIG. 10 depicts the velocity control signal for the first 5 seconds. The two positive velocity parabolas are easily identified at (T=0) 1000 and (T=1) 1005 and the negative velocity parabola is evident at (T=3) 1010. The initial three seconds highlight how the parabolas are required to reach the proper velocities at T1, T2, and T3.

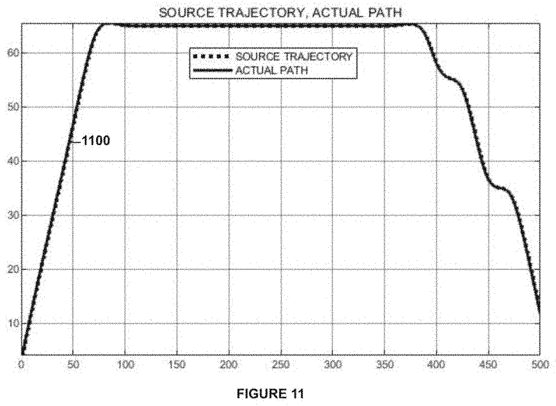

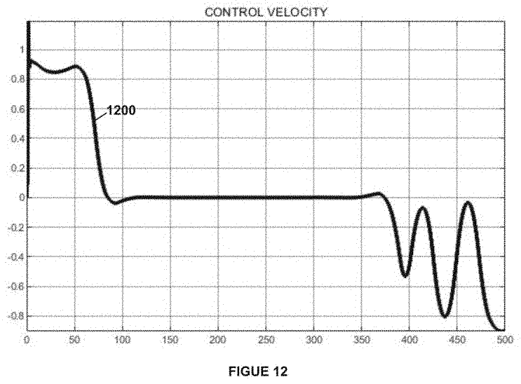

FIG. 11 shows the correlation between the source trajectory 1100 and the actual path for the entire trajectory. Note that this is without any external velocities applied, but it still shows a mathematical error of 0 for the simultaneous solution of location and time.

FIG. 12 shows the control velocity output for the entire path 1200. Note the sinusoidal forms at T=400 to 500 are not oscillations, but velocities induced by the stairsteps of the trajectory at that time.

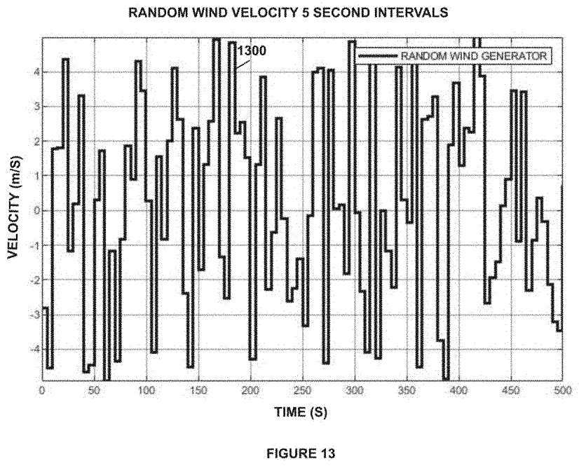

The next step in the exemplar regulator and trajectory is to inject error in terms of overall drag and external applied wind forces. FIG. 13 shows the random wind generator. This is the wind component for the Z dimension only, so it represents updraft and downdraft wind conditions. While the wind direction and intensity are random, the intensity is limited to 5 m/s with a drag coefficient of 0.1. This means that a 5 m/S wind would have sufficient drag on the vehicle to alter its trajectory by 0.5 m/s. Changes in the wind variable occur every 5 seconds.

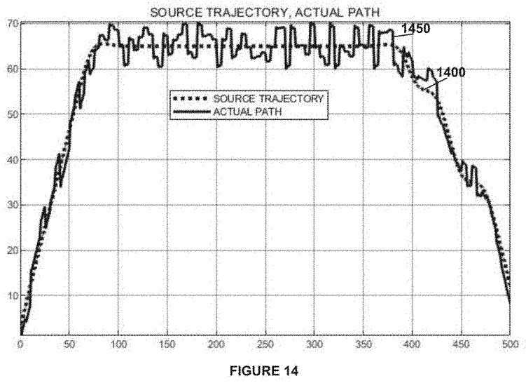

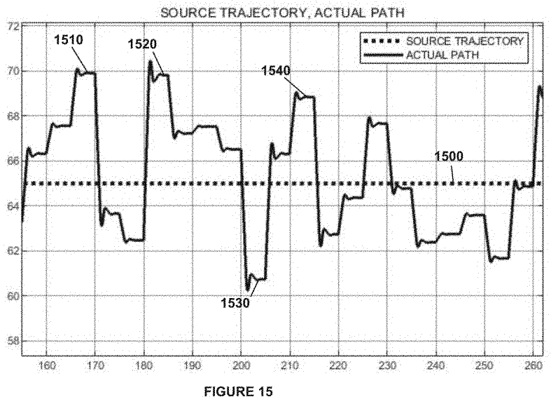

FIG. 14 depicts the source trajectory 1400 and actual path 1450 with the wind velocity added. It can be seen that the wind causes significant deviation from the source trajectory. In FIG. 15 a closer view of this deviation is shown with the dotted line as the source trajectory 1500 and the actual path 1510. An important observation of this effect is that while the deviations are significant, they indicate that an equilibrium state is reached between the wind force and the regulator's ability to compensate for it. This is evidenced by the plateaus in the path deviation at 165 seconds 1510, 180 seconds 1520, 200 seconds 1530, and 210 seconds 1540. The plateaus are also visible in the negative direction and, in effect, visible on each of the 5 second intervals. The equilibrium reached is proportional to the magnitude of the wind force.

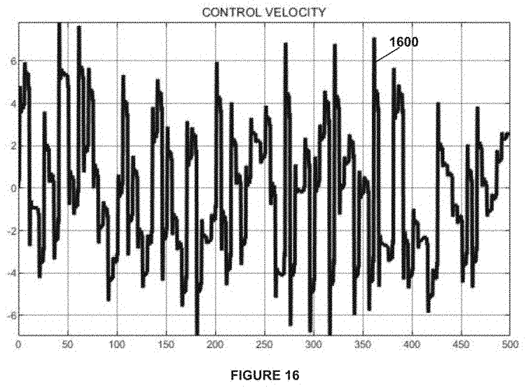

FIG. 16 depicts the control velocity 1600 necessary to counter the deviation caused by the wind. Note in this embodiment and example that velocities in excess of 6 m/s are required in the abrupt changes from one speed and direction to another, even though the average velocity of the vehicle is only 1 m/s.

This plateau effect is due to the fact that the control curve is derived as the exact fit of the requirements of a given one-second interval. Within that sample interval, transients in the location and velocity will be exactly countered in the next interval. Longer term disturbances, however, create this equilibrium effect as the first interval detects and corrects for the deviation in that interval. During this interval, however, the effect continues to exist, so it is also present in the next interval. For example, if a 5 m/s wind gust occurs and the drag coefficient is 0.1, the vehicle will drift off by 0.5 m. In the next time interval, an opposing force to compensate for the 0.5 m drift is added to the velocity, but at the same time the original 5 m/s wind still exists, so equilibrium is reached.

To counter this effect, a second error term is introduced. As shown previously in FIG. 2, it is possible to compute 113 114 the Z distance that would be traveled at the velocity set by the second calculation block 107 without the external disturbance. This is then compared 114 during each subsample of 0.1 seconds to the actual distance traveled with the disturbance 109 and the result is the value of this equilibrium point in meters/second. We can then feed this error term directly into the next control signal to compensate for it, albeit one sub-sample behind the time. While the regulator can, within bounds, anticipate the velocity of the next sample time, it cannot anticipate transitory and external forces and so will respond one sample later.

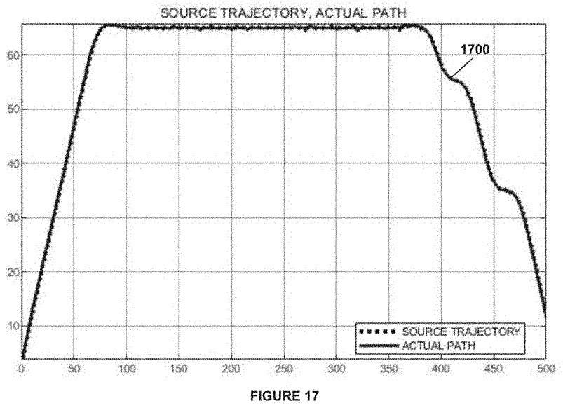

FIG. 17 depicts the source trajectory vs actual path 1700 with this second error term employed.

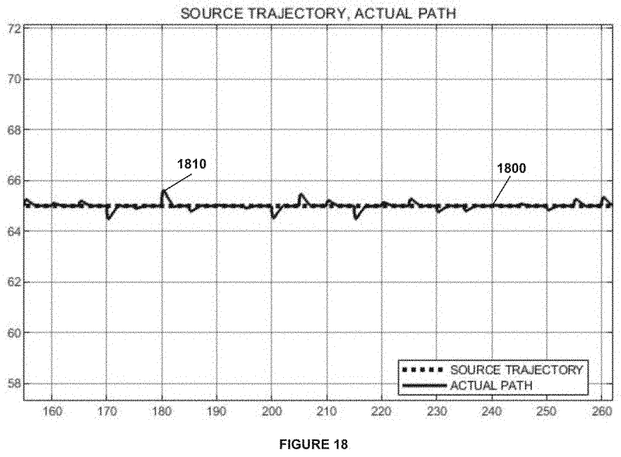

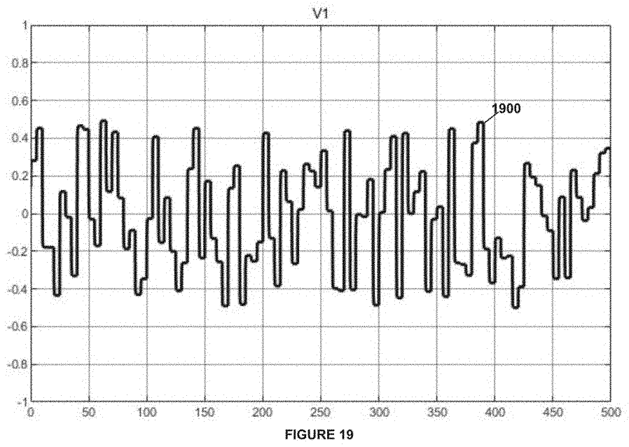

FIG. 18 shows a close-up view of the actual path 1800 at the same calibration as the previous trajectory error chart FIG. 15. This shows significant reduction and eventual elimination of the wind errors. The highest transients at 180 1810 and other areas still cause some error but they are eliminated in a few samples. In another embodiment, a tertiary or additional error terms could be added to further eliminate these errors, but eventually they become an exercise in diminishing returns. FIG. 19 shows the resultant error term 1900 and its relation to the wind plateaus is evident.

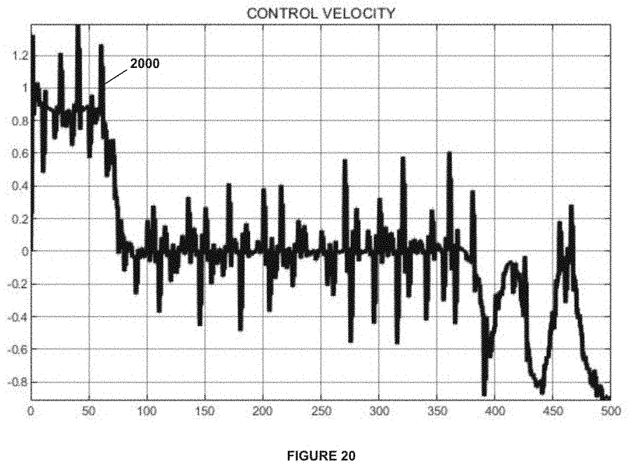

FIG. 20 shows the magnitude of the velocity component necessary to counteract the wind events. In another embodiment this value can be compared against the max and min velocity or power that can be achieved by the vehicle, actuator, or system and the output may be modified such that it does not exceed these limits. This may create additional error, which if tracked can be made up for at later sample times.

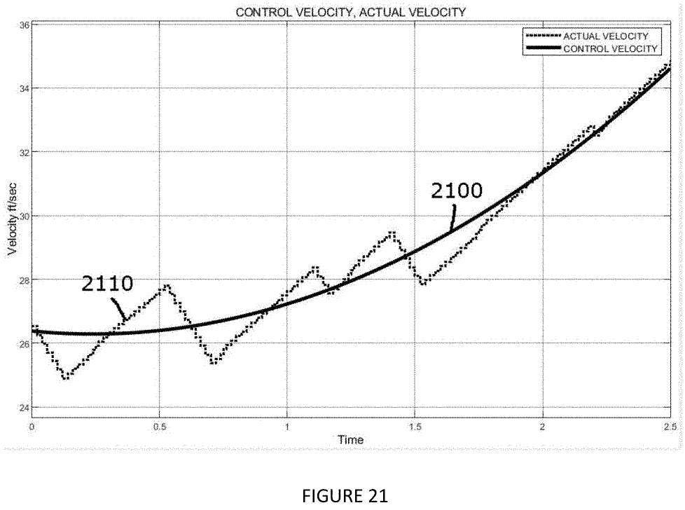

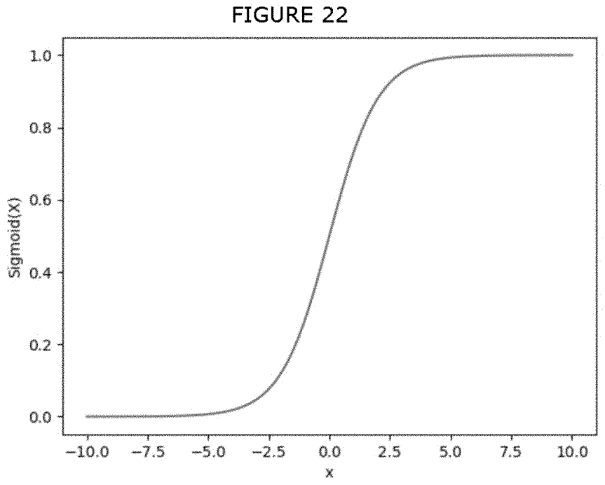

Similarly, FIG. 21 displays an alternative use of the algorithm, in that the polynomial of the output is utilized to compute a single parabola for the entire controlled trajectory of the vehicle. In this example the solid line 2100 is the optimal solution for traversing the given distance with the given starting and ending velocities. A secondary regulator may then control the system to keep it as close to this optimal regulation as possible. In this example the dotted line 2110 is the actual control signal, which has limited points where the system can exert control over the system. Some actual velocities are therefore higher than the optimal, and some lower. The error of the system is the total of the areas of these triangles, and the system utilizes an estimate of computing the velocity such that the higher and lower triangles nearly cancel each other out resulting in a very low overall error.

In another embodiment a polynomial or other mathematical expression is utilized in a similar manner to simultaneously solve for the distance and velocity change over time. For example without limitation, a sigmoid function for matching two disjoint control signals is calculated to provide a smooth transition. This could occur in a robotics application where the control trajectory is suddenly switched, and the sigmoid provides a smooth transition for the position and velocity and the time may be a variable.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Further, different illustrative embodiments may provide different benefits as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

Implementation of the CPR may be performed in computer systems, hardware, or software, including but not limited to Von Neumann architecture machines, Field Programmable Gate Arrays, hardware accelerators, graphics accelerators, learning systems, AI processors and algorithms, optimization systems and architectures, custom or mass-produced silicon, simulators of any of the above, or cloud computing.

1. A solution to a system of simultaneous equations where an exact mathematical solution to a multivariate signal path or physical trajectory problem includes time and allows a control regulator to maintain high accuracy simultaneously over multiple variables such as but not limited to distance, velocity, and time.

2. The trajectory solution system of 1 where the trajectory problem consists of maintaining a specified and/or predictable distance along a path in multiple dimensions referencing a number of mathematically defined physical coordinates in a system such as but not limited to Cartesian, North East Down (NED), Global Positioning System, Inertial, Quasi-Inertial, Osculating-Conic, and/or Geodetic, while manipulating velocity as a polynomial equation within each sample time and said solution may vary sample time.

3. The trajectory solution system of 1 where the signal path problem consists of a time-varying electrical or other signal and accurately maintaining a particular value for that signal as a function of time manipulating the rate of change of that signal and/or sample time of the signal.

4. A control system or regulator implemented with the mathematical solution of 1 which receives time and a target trajectory in some number of axes or dimensions as input from which the starting value, starting rate of change of the value, target ending value, and target ending rate of change of the value for each sample time period may be calculated with which the regulator calculates a polynomial which manipulates the rate of change of a plant or system control signal output to some plant which uses the control signal for its internal operation and returns information including or related to the control signal as feedback to the controller such that the difference between the plant's actual state and the predicted state may be calculated and compensated such that the plant system's trajectory matches the defined target trajectory in value and time.

5. A control system or regulator where the polynomial of 1 is utilized as the desired profile of the entire solution, and a secondary regulator is utilized to maintain the control signal of the system as close to the desired profile as possible.

6. A control system or regulator where the polynomial of 1 other mathematical expression is utilized in a similar manner to simultaneously solve for the distance and velocity change over a variable of time. For example, without limitation, a sigmoid function for matching two disjoint control signals is calculated to provide a smooth transition.
